(19) United States
(12) Patent Application Publication
(10) Pub. No.: US 2018/0148534 A1
(43) Pub. Date: May 31, 2018

(54) BLOCKED ISOCYANATE TERMINATED PREPOLYMERS WITH IMPROVED PROCESSING PROPERTIES

(71) Applicant: LANXESS Solutions US Inc., Middlebury, CT (US)

(72) Inventors: Zhenya Zhu, New Milford, CT (US); Gerald King, Derry (GB); George Brereton, Mahopac, NY (US)

(21) Appl. No.: 15/825,680

(22) Filed: Nov. 29, 2017

Related U.S. Application Data
(60) Provisional application No. 62/427,412, filed on Nov. 29, 2016.

(51) Int. Cl. C08G 18/10; C08G 18/76; C08G 18/18; C08J 5/18

(52) U.S. Cl. CPC C08G 18/10; C08G 18/7614; C08J 2375/04; C08G 18/1816; C08J 5/18; C08G 18/7621

(57) ABSTRACT

Blocked isocyanate terminated prepolymers with improved handling and processing properties are prepared from isocyanate terminated prepolymers with very low free isocyanate monomer content. The blocked prepolymers have lower melting points and/or viscosities compared to similar blocked isocyanate terminated having traditional, higher amounts of free isocyanate monomer. Curing compositions comprising the blocked prepolymers are prepared and cured to form polyurethane polymers with excellent properties.

The present invention provides blocked isocyanate terminated prepolymers with improved handling and processing properties, which blocked prepolymers are obtained from isocyanate terminated prepolymers with very low free isocyanate monomer content, curing compositions comprising the blocked prepolymers and polyurethane polymers prepared therefrom.

### BACKGROUND OF THE INVENTION

Blocked polyisocyanates used in the preparation of polymers such as polyurethanes are known. Blocked polyisocyanates are polyisocyanates in which each isocyanate group has been reacted with a protecting or blocking agent to form a derivative which will dissociate on heating to remove the protecting or blocking agent and release the reactive isocyanate group. For example, blocked polyisocyanates are commonly used in one pack-coating or elastomer compositions which also contain active hydrogen containing compounds, e.g., amines and alcohols. In some applications, e.g., cast molding of elastomeric polyurethanes from prepolymer curing compositions, blocked isocyanates are used because certain otherwise desirable curing agents, such as aromatic diamines, react too quickly with isocyanate groups under typical processing conditions to allow for adequate filling of the mold. Blocked isocyanate terminated prepolymers provide curing compositions that can be cast into a mold or onto a surface and then cured by heating the composition to a temperature above the unblocking temperature.

Compounds that have been used as blocking agents for polyisocyanates can be found, for example, in U.S. Pat. Nos. 3,893,973; 4 150 211; 4,251,414; 4,624,996; 4,696,991 and 5,246,557, and include oximes, lactams, pyrazoles, phenols, various aliphatic monohydric alcohols, N-substituted azalactams, certain hydroxylamines, ketones such as acetone, methyl ethyl ketone, cyclohexanone and acetophenone, imines such as ethyleneimine and polyethyleneimine, and amines such as diphenylamine, aniline and carbazole. Effective blocking agents react with the isocyanate groups at relatively low temperatures, e.g., room temperature, in an equilibrium reaction, which can be reversed in the presence of polyols or polyamines at moderately elevated temperatures to reform the free isocyanate groups that then react with the polyol or polyamine.

The temperatures at which different blocked polyisocyanates dissociate will vary. For example, many blocked isocyanates disassociate at temperatures ranging from 80 C to 160 C. Materials that form a blocked polyisocyanate that are stable at ambient temperatures but will dissociate at a lower temperature are often preferred, largely because of the energy savings involved.

However, certain handling and processing difficulties can arise with blocked isocyanate terminated prepolymers, i.e., blocked isocyanates prepared from an isocyanate terminated prepolymer that was prepared by reacting a polyisocyanate monomer with a polyol. For example, many applications require that the components of a curing composition be in liquid form during molding or coating operations and many blocked isocyanate terminated prepolymers require heating to soften or melt the prepolymer. This can lead to premature deblocking and curing of a composition if the temperature needed to melt or soften the blocked prepolymer is higher than the deblocking temperature. This particular problem can be aggravated by the fact that the melting point of an isocyanate terminated prepolymer is often increased when reacted with a blocking agent.

Therefore, even though blocked isocyanates have been successfully employed used in a variety of applications, the need still exists for improvements in blocked isocyanate technology, especially in relation to blocked isocyanate terminated prepolymers.

### SUMMARY OF THE INVENTION

Blocked isocyanate terminated prepolymers prepared by reacting a blocking agent with a low free monomer isocyanate terminated prepolymer, i.e., a prepolymer prepared from a polyol and polyisocyanate monomer containing less than 1 wt % free polyisocyanate monomer, have a lower melting point and/or a lower viscosity at a given processing temperature than blocked isocyanate terminated prepolymers prepared by reacting the same blocking agent with a conventional isocyanate terminated prepolymer prepared from the same polyol and isocyanate monomer but having a conventional, i.e., higher, amount of free polyisocyanate monomer.

“Given processing temperature” in the above refers to a selected temperature below the deblocking temperature of the blocked isocyanate at which the blocked isocyanate terminated prepolymers prepared from a low free monomer prepolymer and conventional isocyanate terminated prepolymer are molten.

The isocyanate terminated prepolymers referred to herein, both “conventional” and “low free monomer” prepolymers, are known in the art and are prepared by reacting a polyol, typically a diol, with an excess of a polyisocyanate monomer, typically a diisocyanate. As is known in the art, a residual amount of unreacted polyisocyanate monomer remains in the prepolymer, often more than 5 wt % or more than 10 wt % and in some cases concentrations of unreacted free polyisocyanate monomer can be 20 wt % or higher.

Frequently steps are taken to remove at least a portion of the residual polyisocyanate monomer, but many commercial prepolymers still contain much more than 1 wt % free polyisocyanate monomer, e.g., more than 5 wt %, 10 wt % or 20 wt % free monomer. Such prepolymers are referred to herein as “conventional” isocyanate terminated prepolymers.

The “low free monomer” isocyanate terminated prepolymers of the invention are prepared in the same manner as conventional isocyanate terminated prepolymers except that steps, typically involving distillation under vacuum, are taken to reduce the free polyisocyanate monomer content to less than 1 wt %, typically much less, e.g., less than 0.5, 0.1 and in some embodiments less than 0.01 wt %, based on the total weight of prepolymer plus free polyisocyanate monomer.

There is no particular limitation on the blocking agent used, but the invention is especially useful with blocking agents that produce blocked isocyanates with lower disassociation temperatures, e.g., below 120 C or 100 C, such as 90 C or lower, 80 C or lower and 70 C or lower, such as ketoximes, lactams or pyrazoles and the like, as such blocked isocyanates are more likely to disassociate at temperatures encountered in processing a polyurethane prepolymer curing composition.

Various broad embodiments provide blocked isocyanate terminated prepolymers formed from low free monomer isocyanate terminated prepolymers containing less than 1 wt % free polyisocyanate monomer, methods for preparing the blocked isocyanate terminated prepolymers of the invention, and polyurethanes prepared by curing the blocked isocyanate terminated prepolymers of the invention using a polyol or polyamine curative, and, in particular, polyurethanes prepared by curing the blocked isocyanate terminated prepolymers of the invention using a polyamine.

### DESCRIPTION OF THE INVENTION

Embodiments of the invention provide the blocked isocyanate terminated prepolymers with improved handling and processing properties, methods for preparing the blocked prepolymers, curing compositions comprising the blocked prepolymers, and polyurethane polymers prepared therefrom.

One embodiment of the invention provides a blocked isocyanate terminated prepolymer obtained by a process comprising
i) reacting a mixture comprising one or more polyisocyanate monomers, typically diisocyanate monomers, and one or more polyols, typically diols, which reaction mixture comprises a molar excess of isocyanate groups relative to hydroxyl groups, e.g., a molar ratio of from 1.1 to 25:1, e.g., 1.5:1 to 20:1, 3:1 to 20:1 or 3:1 to 15:1 of isocyanate to hydroxyl, under conditions wherein the polyisocyanate monomer and the one or more polyol react to form a prepolymer reaction product comprising a prepolymer having terminal isocyanate groups and unreacted polyisocyanate monomer,
ii) subjecting the prepolymer reaction product to distillation conditions to remove unreacted polyisocyanate monomer, to yield a prepolymer containing less than 1 wt %, e.g., 0.5 wt % or less, e.g., 0.1 wt % or less, free polyisocyanate monomer,
iii) reacting the terminal isocyanate groups of the prepolymer obtained in ii) with a blocking agent, said blocking agent being a compound that reacts with isocyanate groups to form a blocked isocyanate, which blocked isocyanate disassociates at selected elevated temperatures to reform the isocyanate groups and blocking agent.
Known blocking agents that can be used in various embodiments of the invention include:
ketoximes, such as acetophenone oxime, acetone oxime, methyl ethyl ketoxime, and cyclohexanone oxime, cyclopentanone oxime, benzophenone oxime, methyl isobutyl ketone oxime and the like;
aldoximes such as propyl aldehyde oxime, formaldoxime, butyl aldehyde oxime, and the like; lactams, such as lactams of omega-aminocarboxylic acids, e.g., lactams from 3-aminopropionic acid, 4-aminobutyric acid, 5-aminovaleric acid, 6-aminocaproic acid (epsilon caprolactam), 10-aminocapric acid etc, and
   N-substituted azalactams, such as 1-N-methyl-hexahydro-1,4,-diazepinone-(3), 1-N-butyl-hexahydro-1,4-diazepinone-(3), 1-N-benzyl-hexahydro-1,4-diazepinone-(3), 1-N-α-pyridyl-hexahydro-1,4-diazepinone-(3), etc.
pyrazoles such as 3,5-dimethylpyrazole, 3-methylpyrazole, and the like;
other amines, e.g., aromatic amines such as diphenylamine, aniline, carbazole, ketones such as acetone, methyl ethyl ketone, diethyl ketone, cyclohexanone, acetophenone, benzophenone and the like;
imines such as ethyleneimine, polyethyleneimine and the like;
hydroxylamines such as hydroxy-tertiary amines etc.; and
monohydric alcohols, including aliphatic alcohols such as methanol, ethanol, butanol, hexanol, dimethyl-amino ethanol etc.,
   cycloaliphatic alcohols such as cyclohexanol etc.,
   aralkyl monohydric alcohols such as benzyl alcohol etc., and
   aromatic alcohols such as phenol, cresol, ethylphenol, butylphenol, nonylphenol,
   dinonylphenol, styrenated phenol, and hydroxybenzoic acid esters.

As stated above, the blocked isocyanate terminated prepolymers of the invention having lower melting points or viscosities are particularly useful when the blocking agent is known to produce blocked isocyanates that disassociate at lower temperatures, because such blocked isocyanates may disassociate at temperatures needed to provide a liquid or free flowing blocked prepolymer obtained from a conventional prepolymer. Therefore, in some particular embodiments, the blocking agent is a compound that produces blocked isocyanates with deblocking temperatures of less than 120 C, less than 100 C, less than 90 C or 80 C or lower. For example, the blocking agent in such embodiments often comprises a ketoxime, lactam or pyrazole, e.g., methyl ethyl ketoxime or cyclohexanone oxime, pyrollidone, epsilon caprolactam, 3,5-dimethylpyrazole or 3-methylpyrazole, and the like. For example, excellent results have been obtained using methyl ethyl ketone oxime or caprolactam as blocking agents.

The present invention is also of particular value when the curative is a polyamine, e.g., aromatic or aliphatic diamines. Amino curatives, such as certain aromatic diamines, are known to produce tough polyurethane elastomers and thermoplastics, but compositions comprising a polyamine and an isocyanate terminated prepolymer cure very rapidly, often too rapidly for proper processing. By providing blocked prepolymers with lower melting points or viscosities, the present invention expands the palette of prepolymers available for producing high performance urethane polymers, e.g., cast molded elastomers.

In the preparation of polyurethane prepolymers, it is common to use large excesses of the monomeric polyisocyanates in order to minimize the formation of high molecular weight products and generate well defined prepolymer structures. For example, linear, isocyanate terminated prepolymers having a regular structure, such as a configuration ABA, ABABA and the like, where A represents a group derived from a diisocyanate monomer and B represents a group derived from a diol, are known to provide elastomeric polyurethanes with excellent physical properties. However, the use of such an excess of diisocyanate monomer results in an undesirable amount of unreacted, typically volatile, diisocyanate monomer in the prepolymer reaction product mixture. Various processes have been developed to reduce the quantity of unreacted monomeric diisocyanate levels in prepolymers including methods that use falling film evaporators, wiped film evaporators, other distillation techniques, solvent extraction, and molecular sieves. Of these processes, the use of evaporators and distillation is much simpler and more economical than solvent extraction or molecular sieve adsorption. However, in the distillation of diisocyanate monomers from polyurethane prepolymers, high temperatures must be avoided to prevent decomposition reactions in the prepolymer.

U.S. Pat. No. 4,182,825 discloses a process to reduce the amount of diisocyanate by distilling a prepolymer reaction product under vacuum conditions. U.S. Pat. No. 4,385,171 discloses a method for the removal of unreacted diisocyanate monomer from prepolymers by codistilling the prepolymer reaction product with a compound that boils at a temperature greater than the boiling point of the diisocyanate. U.S. Pat. No. 4,888,442 discloses a process for reducing the free monomer content of polyisocyanate adduct mixtures comprising distillation of a mixture of the polyisocyanate adduct mixture with 2 to about 30 percent by weight of an inert solvent.

US Pub Pat Appl 20030065124 discloses removing excess diphenylmethane diisocyanate (MDI), from prepolymer product by subjecting the prepolymer product mixture to distillation under vacuum presence of an inert solvent having a boiling point of from 1° C. to 100° C. below that of the diisocyanate at a vacuum of 10 torr. U.S. Pat. No. 5,703,193 describes a process for reducing the amount of residual polyisocyanate monomer, specifically PPDI monomer, in prepolymers by co-distilling the reaction product in the presence of a combination of two inert solvents, with the first inert solvent having a boiling point below the boiling point of the diisocyanate monomer and the second inert solvent having a boiling point above the boiling point of the diisocyanate monomer.

Any process useful in reducing the free isocyanate monomer in the prepolymer content to the low levels of the invention may be employed in the invention, but distillation under reduced pressure is typically used, e.g., thin film or agitated film evaporation under vacuum has been used with good success.

Almost any polyisocyanate monomer known in the art may be used to prepare the prepolymer, including diphenylmethane diisocyanates, toluene diisocyanates, phenylene diisocyanates, diphenyl diisocyanates, dibenzyl diisocyanates, naphthalene diisocyanates, benzophenone diisocyanates, xylene diisocyanates, hexane diisocyanates, isophorone diisocyanate, bitoluene diisocyanates, cyclohexyl diisocyanates, methylene biscyclohexyl isocyanates and the like.

Various examples of particular isocyanates include, paraphenylene diisocyanate (PPDI), toluidine diisocyanate (TODI), isophorone diisocyanate (IPDI), 2,4- and/or 4,4′-methylene bis (phenylisocyanate) (MDI), toluene-2,4-diisocyanate (2,4-TDI), toluene-2,6-diisocyanate (2,6-TDI), naphthalene-1,5-diisocyanate (NDI), diphenyl-4,4′-diisocyanate, dibenzyl-4,4′-diisocyanate, stilbene-4,4′-diisocyanate, benzophenone-4,4′diisocyanate, 1,3- and 1,4-xylene diisocyanates, 1,6-hexamethylene diisocyanate (HDI), 1,3-cyclohexyl diisocyanate, 1,4-cyclohexyl diisocyanate (CHDI), the three geometric isomers of 1,1′-methylene-bis(4-isocyanatocyclohexane) (abbreviated collectively as H₁₂ MDI), and mixtures thereof. In certain embodiments the polyisocyanate monomer component comprises MDI, PPDI, 2,4-TDI, 2,6-TDI, HDI and/or H₁₂MDI, often MDI, PPDI, 2,4-TDI and/or 2,6-TDI.

In the present application, the article “a” or “an” means one or more than one unless otherwise specified, and more than one polyisocyanate monomer may be used in the reaction.

Polyols used in the preparation of the present prepolymers may be selected from any polyol known in the art, for example, polyether polyols, polyester polyols, polycaprolactone polyols, polycarbonate polyols, co-polyester polyols, alkane polyols, or mixtures thereof. In many embodiments the polyol will have a number average molecular weight from about 200, 250 or 400 to about 6000 or 10,000 Daltons, in some embodiments a lower molecular weight polyol may also be present. In many embodiments, diols are preferred over triols and polyols having a larger number of hydroxyl groups.

Despite “ester” being a general term often used to encompass acyclic and cyclic esters, and sometimes even “carbonates”, one skilled in the art recognizes that materials sold as polyester polyols, polycaprolactone polyols, and polycarbonate polyols have, and generally impart to the prepolymer and polyurethane, different characteristics, and are marketed as different materials. In the present application, the terms “polyester polyol”, “polycaprolactone polyol”, and “polycarbonate polyol” are used to refer to three separate materials. “Polyester polyol” as used herein refers to a polyol having a backbone derived mainly from a polycarboxylate and a poly alcohol, e.g., a majority of the ester linkages in the backbone are derived from a polycarboxylate and a polyol, such as found in poly(ethylene adipate) glycol:

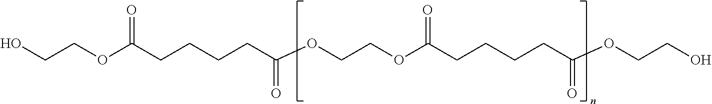

“Polylactone polyol” as used herein refers to a polyol having a backbone derived mainly from a hydroxycarboxylic acid or lactone, as opposed to being derived from a polycarboxylate and a polyol, as found in poly caprolactone:

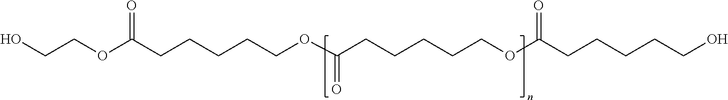

“Polycarbonate polyol” as used herein refers to a polyol having a backbone comprising mainly carbonate linkages, —O(CO)—O—, as opposed to carboxylate linkages, —O(CO)—R wherein R is a hydrogen or an organic radical bound to the carbonyl by a C—C bond.

“Co-polyester polyols”, as used herein refers to a polyol wherein a portion of the backbone is derived from a polycarboxylate and a poly alcohol as described above, and a portion of the backbone is derived from a hydroxyacid or lactone, or which also incorporates carbonate linkages.

For example, useful polyols may include polyesters of adipic acid or other dicarboxylic acids; polyethers of ethylene oxide, propylene oxide, 1,3-propanediol, tetrahydrofuran, etc.; polycaprolactone (PCL), polycarbonate, and copolymers and terpolymers formed from the above, and mixtures thereof. In various optional embodiments, the polyol comprises glycols or triols having molecular weights ranging, for example, from 60 to 400, e.g., from 80 to 300 or from 100 to 200, for example, such glycols or triols may include ethylene glycol, isomers of propylene glycol, isomers of butane diol, isomers of pentanediol, isomers of hexanediol, trimethylolpropane, pentaerythritol, diethylene glycol, triethylene glycol, dipropylene glycol, tripropylene glycol, etc., and mixtures thereof.

Often, the polyether polyol is a polyalkylene ether polyol represented by the general formula HO(RO)ₙH, wherein R is an alkylene radical and n is an integer large enough that the polyether polyol has a number average molecular weight of at least 250. These polyalkylene ether polyols are well-known components of polyurethane products and can be prepared by the polymerization of cyclic ethers such as alkylene oxides and glycols, dihydroxyethers, and the like by known methods. Representative polyols include polyethylene ether glycols, polypropylene ether glycols (PPG), copolymers from propylene oxide and ethylene oxide (PPG-EO glycol), poly(tetramethylene ether) glycol (PTMEG or PTMG), and the like.

The polyester polyols are typically prepared by reaction of dibasic acids, e.g., adipic, glutaric, succinic, azelaic, sebacic, or phthalic acid or derivatives thereof, with diols such as ethylene glycol, 1,2-propylene glycol, 1,4-butylene glycol, 1,6-hexylene glycol, and alkylene ether polyols such as diethylene glycol, polyethylene glycol, polypropylene glycols, polytetramethylene ether glycol and the like. Polyols such as glycerol, trimethylol propane, pentaerthythritol, sorbitol, and the like may be used if chain branching or ultimate cross-linking is sought. Examples of polyester polyols include poly(adipate) glycol, poly(hexamethylene adipate) glycol, poly(ethylene adipate) glycol, poly(diethylene adipate) glycol, poly(ethylene/propylene adipate) glycol, poly(trimethylolpropane/hexamethylene adipate) glycol, poly(ethylene/butylene adipate) glycol, poly(butylene adipate) glycol, poly(hexamethylene/neopentyl adipate) glycol, poly(butylene/hexamethylene adipate) glycol (PBHAG), poly(neopentyl adipate) glycol, and the like including copolymers and terpolymers thereof.

Polylactone polyols include those made by polycondensation of, e.g., a caprolatone such as ε-caprolactone, and the like, often initiated by a small polyol such as ethylene glycol.

Hydrocarbon polyols can be prepared from ethylenically unsaturated monomers such ethylene, isobutylene, and 1,3-butadiene, e.g., polybutadiene polyols and the like.

Polycarbonate polyols can also be used in forming the prepolymers of the invention and can be prepared by reaction of glycols, e.g., 1,6-hexylene glycol and the like, with organic carbonates, e.g., diphenyl carbonate, diethyl carbonate, or ethylene carbonate and the like.

Co-polyester polyols of the invention include those wherein the backbone comprises polyester portions and portions comprising caprolactone or polycaprolactone.

The curing composition of the invention comprises one or more blocked isocyanate terminated prepolymers and one or more curing agent. Curing agents, also called coupling agents, cross linking agents or chain extenders, are well known in the art and include various diols, triols, tetrols, diamines or diamine derivatives and the like. Common curing agents include: C₂₋₁₂ alkylene diols such as ethylene glycol, 1,3-propanediol, 1,4-butanediol, 1,5-pentanediol, 1,6-hexanediol, neopentyl glycol, trimethylol propane, 1,10-decanediol, 1,1-cyclohexane dimethanol, 1,4-cyclohexane dimethanol, cyclohexane diol and the like; hydroquinone-bis-hydroxyalkyl ethers such as hydroquinone-bis-hydroxyethyl ether, diethylene glycol etc.; ether diols such as dipropylene glycol, dibutylene glycol, triethylene glycol and the like;

and a variety of diamines including ethylene diamine, hexamethylene diamine, isophorone diamine, xylylene diamine, methylenedianiline (MDA), naphthalene-1,5-diamine, ortho, meta, and para-phenylene diamines, toluene-2,4-diamine, dichlorobenzidine, diphenylether-4,4′-diamine, 4,4′-methylene-bis(3-chloroaniline) (MBCA), 4,4′-methylene-bis(3-chloro-2,6-diethylaniline) (MCDEA), diethyl toluene diamine (DETDA), tertiary butyl toluene diamine (TBTDA), dimethylthio-toluene diamine, trimethylene glycol di-p-amino-benzoate, 1,2-bis(2-aminophenylthio)ethane, and methylenedianiline-sodium chloride complexes.

In select embodiments the curing agent comprises an aromatic diamine, e.g., a methylenedianiline, toluene diamine, xylylene diamine, phenylene diamine, and the like; specific examples include, 4,4′-methylenedianiline (MDA), 4,4′ methylene-bis-2,6 diethyl aniline (MDEA) ortho, meta, and para-phenylene diamines, toluene-2,4-diamine, 4,4′-methylene-bis(3-chloroaniline) (MBCA), 4,4′-methylene-bis(3-chloro-2,6-diethylaniline) (MCDEA), diethyl toluene diamine (DETDA), dimethylthio-toluene diamine, and trimethylene glycol di-p-amino-benzoate.

The molar ratio of prepolymer to curing agent in the curing composition is in the range of from 0.5:1 to 1.5:1, e.g., from 0.7:1 to 1.2:1 or from 1.1:1 to 0.95:1. The amount of curing agent is determined by methods well known to one of ordinary skill in the art and will depend on the desired characteristics of the resin being formed.

In some embodiments, the curing composition also contains a catalyst. A variety of catalysts are known in the art for improving the rate at which a prepolymer is cured, e.g., acid catalysts, amine catalysts, metal and organometallic catalysts, acid and ammonium salts etc., and any such catalyst may be used. For example, the catalyst may comprise one or more of adipic acid, oleic acid, dibutyltin dilaurate, a quaternary ammonium salt, such as a quaternary ammonium salt in ethylene glycol, and the blends of above. Typically, the catalyst is present in the curing composition in an amount that is about 0.001 to about 1.0% of the weight of the one or more curing agent, e.g., the curing composition comprises from about 0.001 to about 2.0 wt %, based on the weight of the one or more curing agent, of a catalyst. In some embodiments, the curing composition comprises from about 0.005 to about 1.0 or from about 0.01 to about 0.5 wt %, based on the weight of the one or more curing agent, of a catalyst.

Particular embodiments of the invention relate to polyurethane elastomers formed by cast molding, or by casting films on a surface, although other molding processes may be used, e.g., injection molding and the like. In such applications it is generally important for the curing composition to be a flowable liquid, e.g., in order to fill a mold before curing is complete. The prepolymer is therefore often heated to melt it or to reduce its viscosity before it is combined with the curing agent. The curing agent may also need to be heated. After casting into a mold or onto a surface, the curing composition is further heated, typically at higher temperatures to induce or complete cure. The low melting point or lower viscosity of the present prepolymer is advantageous in such applications as the inventive blocked prepolymers will require lower temperatures before becoming flowable liquids than conventional blocked prepolymers.

Other materials common in the art may also be present in the prepolymer composition, curing composition, and polymer of the invention including catalysts, dispersants, colorants, fillers, reinforcing agents, solvents, plasticizers, anti-oxidants, UVAs, light stabilizers, lubricants, processing aids, anti-stats, flame retardants, and the like.

Other embodiments provide a method for casting a polyurethane elastomer comprising the prepolymer of the invention and the elastomer itself. The elastomers are prepared by casting the inventive curing composition into a mold or onto a surface and heating above the deblocking temperature to cure the composition. Often, after an initial curing step, a post-curing step will be used which may involve higher temperatures and/or a longer period of time.

### EXAMPLES

Preparation of Blocked Isocyanate Terminated Prepolymers

### Example I

Methyl Ethyl Ketoxime (MEKO) Blocked LF PPDI Prepolymer

To 800 parts ADIPRENE LFP E560, p-phenylene diisocyanate/polyether prepolymer having % NCO of 5.60 and less than 0.1 wt % free PPDI monomer, in a batch reaction flask equipped with nitrogen sweep, agitator, thermometer, heating mantle, and vacuum source was added 93 parts MEKO, molar ratio of NCO to MEKO was 1:1, and the resulting reaction mixture was heated for 2 hours at 80 C under a vacuum of 1-10 torr to provide the MEKO blocked prepolymer with a melting point of less than 70 C.

### Comparative Example A

Methyl Ethyl Ketoxime (MEKO) Blocked Conventional PPDI Prepolymer

To 800 parts of a PPDI/polytetramethylene ether glycol prepolymer having % NCO of 6.50 and 3.5 wt % free PPDI in a batch reaction flask equipped with nitrogen sweep, an agitator, a thermometer, a heating mantle, and a vacuum source was added 108 parts of MEKO, molar ratio of NCO to MEKO was 1:1, and the resulting reaction mixture was heated for 2 hours at 80 C under a vacuum of 1-10 torr to provide the MEKO blocked prepolymer with a melting point of greater than 80 C.

### Example II

Methyl Ethyl Ketoxime (MEKO) Blocked LF TDI Prepolymer

To 800 parts ADIPRENE LF 950A, toluene diisocyanate/polyether prepolymer having % NCO of 6.00 and less than 0.1 wt % free TDI monomer, in a batch reaction flask equipped with nitrogen sweep, agitator, thermometer, heating mantle, and vacuum source was added 109 parts MEKO, molar ratio of NCO to MEKO was 1:1, and the resulting reaction mixture was heated for 2 hours at 80 C to provide the MEKO blocked prepolymer with a melting point of less than 70 C.

### Comparative Example B

Methyl Ethyl Ketoxime (MEKO) Blocked Conventional TDI Prepolymer

To 800 parts of a TDI/polytetramethylene ether glycol prepolymer having % NCO of 6.40 and 2.5 wt % free TDI in a batch reaction flask equipped with nitrogen sweep, an agitator, a thermometer, a heating mantle, and a vacuum source was added 106 parts of MEKO, molar ratio of NCO to MEKO was 1:1, and the resulting reaction mixture was heated for 2 hours at 80C under a vacuum of 1-10 torr to provide the MEKO blocked prepolymer with a melting point of greater than 80 C.

### Example III

Caprolactam Blocked LF Prepolymer

To 800 parts ADIPRENE LFP C380, p-phenylene diisocyanate/polycaprolactone prepolymer having % NCO of 3.80 and less than 0.1 wt % free PPDI monomer, in a batch reaction flask equipped with nitrogen sweep, agitator, thermometer, heating mantle, and vacuum source was added 82 parts caprolactam, molar ratio of NCO to caprolactam was 1:1, and the resulting reaction mixture was heated for 2 hours at 80 C under a vacuum of 1-10 torr to provide the caprolactam blocked prepolymer with a melting point of less than 70 C.

### Example IV

Caprolactam Blocked LF Prepolymer

To 800 parts ADIPRENE LFP R375, p-phenylene diisocyanate/polycarbonate prepolymer having % NCO of 3.80 and less than 0.1 wt % free PPDI monomer, in a batch reaction flask equipped with nitrogen sweep, agitator, thermometer, heating mantle, and vacuum source was added 82 parts caprolactam, molar ratio of NCO to caprolactam was 1:1, and the resulting reaction mixture was heated for 2 hours at 80 C under a vacuum of 1-10 torr to provide the caprolactam blocked prepolymer with a melting point of less than 70 C.

### Example V

Caprolactam Blocked LF Prepolymer

To 800 parts ADIPRENE LFM E370, methylene diisocyanate/polyether prepolymer having % NCO of 3.70 and less than 0.1 wt % free MDI monomer, in a batch reaction flask equipped with nitrogen sweep, agitator, thermometer, heating mantle, and vacuum source was added 80 parts caprolactam, molar ratio of NCO to caprolactam was 1:1, and the resulting reaction mixture was heated for 2 hours at 80 C under a vacuum of 1-10 torr to provide the caprolactam blocked prepolymer with a melting point of less than 70 C.

### Example VI

Caprolactam Blocked LF Prepolymer

To 800 parts ADIPRENE LFM E450, Methylene diisocyanate/polyether prepolymer having % NCO of 4.50 and less than 0.1 wt % free MDI monomer, in a batch reaction flask equipped with nitrogen sweep, agitator, thermometer, heating mantle, and vacuum source was added 97.3 parts caprolactam, molar ratio of NCO to caprolactam was 1:1, and the resulting reaction mixture was heated for 2 hours at 80 C under a vacuum of 1-10 torr to provide the caprolactam blocked prepolymer with a melting point of less than 70 C.

TABLE 1
Viscosity comparison of blocked prepolymers

| Example | II | Comp B |
|---|---|---|
| Prepolymer | MEKO blocked | MEKO blocked |
| | LFTDI/Ether | conventional |
| | | TDI/Ether |
| Viscosity at 50 C., cps | 9,200 | 11,300 |

MEKO blocked isocyanates start to de-block at temperature above 80 C. As seen in Comparative Example A, the MEKO blocked conventional PPDI prepolymer has a higher melting point and is likely to prematurely deblock and cure if used as a liquid in a polyurethane curing composition. Also, as demonstrated in Table 1, blocked prepolymer made from LF prepolymer has lower viscosity comparing to non-LF counterpart, which facilitates the process.

Preparation of Polyurethane Elastomers

### Example VII

To 100 g of the MEKO blocked prepolymer of Example I was added 39.2 g of a 30% solution of methylene dianiline (MDA) in PM acetate and after mixing the resulting mixture was poured onto a metal surface and cured/post cured at 125 C for 16 hours to provide tough, elastomeric polyurethane films.

### Example VIII

To 100 g of the MEKO blocked prepolymer of Example I was added 18.4 g of molten methylene-bis(2,6-diethylaniline) (MDEA) and after mixing the resulting mixture was poured onto a metal surface and cured/post cured at 125 C for 16 hours to provide tough, elastomeric polyurethane films.

### Example IX

To 100 g of the caprolactam blocked prepolymer of Example III was added 12.8 g of molten methylene-bis(2,6-diethylaniline) (MDEA) and mixed. Tough molded articles are prepared by pouring the mixture into a mold and curing at 150 C.

### Example X

To 100 g of the caprolactam blocked prepolymer of Example IV was added 15.6 g of molten 4,4′-methylene-bis(3-chloro-2,6-diethylaniline) (MCDEA) and mixed. Tough molded articles are prepared by pouring the mixture into a mold and curing at 150 C.

### Example XI

To 100 g of the caprolactam blocked prepolymer of Example V was added 12.4 g of molten methylene-bis(2,6-diethylaniline) (MDEA) and mixed to provide a one component (1 K) system having good stability at room temperature. At a desired time, it could be poured into a mold and deblocked at 180 C. Tough molded articles are prepared after post curing at 120 C for 14 h.

### Example XII

To 100 g of the caprolactam blocked prepolymer of Example VI was added 15.1 g of molten methylene-bis(2,6-diethylaniline) (MDEA) and mixed to provide a one component (1 K) system with good stability at room temperature. Tough molded articles are prepared by pouring the mixture into a mold and curing at 150 C.

### Comparative Example C

To 100 g of VIBRATHANE B670, conventional methylene diisocyanate/polyether prepolymer having % NCO of 11.20 and greater than 20% free MDI was added 10.5 g butane diol and 26 g VIBRACURE A122 diol curative, and after mixing the mixture was poured into a mold and cured/post cured at 115-120 C for 16 h.

### Comparative Example D

To 100 g of VIBRATHANE B670, conventional Methylene diisocyanate/polyether prepolymer having % NCO of 11.20 and greater than 20% free MDI was added 8.8 g butane diol and 64.9 g VIBRACURE A122 diol curative, and after mixing the mixture was poured into a mold and cured/post cured at 115-120 C for 16 h.

### Comparative Example E

To 100 g of ADIPRENE LFP E560, LF p-Phenylene diisocyanate/Polyether prepolymer having % NCO of 5.60 was added 5.7 g butane diol curative, and after mixing the mixture was poured into a mold and cured/post cured at 115-127 C for 16 h.

### Comparative Example F

To 100 g of ADIPRENE LFP R375, LF p-phenylene diisocyanate/polycarbonate prepolymer having % NCO of 3.80 was added 3.9 g butane diol curative, and after mixing the mixture was poured into a mold and cured/post cured at 115-127 C for 16 h.

TABLE 2
Elastomer properties after deblocking/curing the prepolymers

| | Ex VII | Ex VIII | Ex IX | Ex X | Ex XI | | |
|---|---|---|---|---|---|---|---|
| | MEKO | MEKO | Lactam | Lactam | Lactam | Comp Ex | Comp Ex |
| | blocked | blocked | blocked | blocked | blocked | C | D |
| | LFPPDI/ | LFPPDI/ | LFPPDI/ | LFPPDI/ | LFMDI/ | Unblocked | Unblocked |
| prepolymer | Ether | Ether | Cap | Carb | Ether | MDI/Ether | MDI/Ether |
| Curing | MDA | MDEA | MDEA | MCDEA | MDEA | diol | diol |
| agent | | | | | | | |
| Hardness | 95 A | 95 A | 82 A | 95 A | 88 A | 95 A | 80 A |
| Split Tear | 210 pli | 144 pli | 106 pli | 175 pli | 102 pli | 96 pli | 52 pli |

Table 2 demonstrates that elastomers made from deblocked/diamine cured LF prepolymers exhibit excellent physical properties having higher tear strength comparing to diol cured conventional MDI prepolymers.

TABLE 3
Elastomer dynamic property comparison

| Example | I | Comp E | X | Comp F |
|---|---|---|---|---|
| Prepolymer | MEKO | Unblocked | Lactam blocked | Unblocked |
| | blocked | PPDI/Ether | LFPPDI/Carb | PPDI/Carb |
| | LFPPDI/ | | | |
| | Ether | | | |
| Curing agent | MDA | diol | MCDEA | diol |
| Storage Modulus at | 710 | 684 | 342 | 325 |
| 30 C., Mdynes/cm² | | | | |
| Storage Modulus at | 610 | 460 | 350 | 169 |
| 180 C., Mdynes/cm² | | | | |

Table 3 demonstrates that elastomers made from deblocked/diamine cured LF prepolymers retain modulus much better than that of diol cured counterpart prepolymers at elevated temperature.

### Example XIII

Effect of Catalyst on Deblocking/Cure Time
XIIIa:

To 100 g of the caprolactam blocked prepolymer of Example II was added 12.8 g of molten methylene-bis(2,6-diethylaniline) (MDEA), the resulting mixture was mixed and then poured into a mold and cured at 150 C until the elastomer could be removed from the mold. Time to cure the elastomer is found in Table 4.
XIIIb:

To 100 g of the caprolactam blocked prepolymer of Example II was added 12.8 g of molten methylene-bis(2,6-diethylaniline) (MDEA) and 0.08 g adipic acid, the resulting mixture was mixed and then poured into a mold and cured at 150 C until the elastomer could be removed from the mold. Time to cure the elastomer is found in Table 4.

TABLE 2
Catalyst effect on deblock/cure time

| Example | XIIIa | XIIIb |
|---|---|---|
| Chain extender | MDEA | MDEA |
| Adipic Acid, wt % | 0 wt % | 0.6% wt |
| Time to cure 150 C. | 30 minutes | 20 minutes |

What is claimed:

1. A blocked isocyanate terminated prepolymer obtained by a process comprising reacting an isocyanate terminated prepolymer containing less than 1 wt % free polyisocyanate monomer with a blocking agent, said blocking agent being a compound that reacts with isocyanate groups to form a blocked isocyanate, which blocked isocyanate disassociates at selected elevated temperatures to reform the isocyanate groups and blocking agent.

2. The blocked isocyanate terminated prepolymer according to claim 1 wherein the blocking agent comprises an oxime, lactam or pyrazole, phenol, hydroxylamine, ketone, imine, diphenylamine, aniline and carbazole.

3. The blocked isocyanate terminated prepolymer according to claim 1 wherein the one or more polyisocyanate monomers comprises one or more diisocyanates and/or the one or more polyols comprises one or more diols.

4. The blocked isocyanate terminated prepolymer according to claim 1 obtained by a process comprising
i) reacting a mixture comprising one or more polyisocyanate monomers and one or more polyols, which reaction mixture comprises a molar excess of isocyanate groups relative to hydroxyl groups, under conditions wherein the polyisocyanate monomer and the one or more polyol react to form a prepolymer reaction product comprising a prepolymer having terminal isocyanate groups and unreacted polyisocyanate monomer,
ii) subjecting the prepolymer reaction product to distillation conditions to remove unreacted polyisocyanate monomer to yield a prepolymer containing less than 1 wt % free polyisocyanate monomer,
iii) reacting the terminal isocyanate groups of the prepolymer obtained in ii) with a blocking agent, said blocking agent being a compound that reacts with isocyanate groups to form a blocked isocyanate, which blocked isocyanate disassociates at selected elevated temperatures to reform the isocyanate groups and blocking agent.

5. The blocked isocyanate terminated prepolymer according to claim 4 wherein the blocking agent comprises an oxime, lactam or pyrazole, phenol, hydroxylamine, ketone, imine, diphenylamine, aniline and carbazole.

6. The blocked isocyanate terminated prepolymer according to claim 5 wherein the blocking agent comprises an oxime, lactam or pyrazole.

7. The blocked isocyanate terminated prepolymer according to claim 6 wherein the blocking agent comprises an oxime or lactam.

8. The blocked isocyanate terminated prepolymer according to claim 6 wherein the blocking agent comprises methyl ethyl ketoxime, cyclohexanone oxime, ε-caprolactam, or 3,5-dimethylpyrazole.

9. The blocked isocyanate terminated prepolymer according to claim 4 wherein the one or more polyisocyanate monomers comprises one or more diisocyanates and/or the one or more polyols comprises one or more diols.

10. The blocked isocyanate terminated prepolymer according to claim 9 wherein the one or more polyisocyanate monomers comprises paraphenylene diisocyanate, toluidine diisocyanate, isophorone diisocyanate, 2,4- and/or 4,4′-methylene bis (phenylisocyanate), toluene-2,4-diisocyanate, toluene-2,6-diisocyanate, naphthalene-1,5-diisocyanate, diphenyl-4,4′-diisocyanate, dibenzyl-4,4′-diisocyanate, stilbene-4,4′-diisocyanate, 1,3-xylene diisocyanate, 1,4-xylene diisocyanate, 1,6-hexamethylene diisocyanate, 1,3-cyclohexyl diisocyanate, 1,4-cyclohexyl diisocyanate, or 1,1′-methylene-bis(4-isocyanatocyclohexane).

11. The blocked isocyanate terminated prepolymer according to claim 9 wherein the one or more polyols comprises an adipic acid polyester glycol, glutaric acid polyester glycol, succinic acid polyester glycol, azelaic acid polyester glycol, sebacic acid polyester glycol, phthalic acid polyester glycol, polyethylene ether glycol, polypropylene ether glycol, PPG-EO glycol, polytetramethylene ether glycol, polycaprolactone glycol, or polycarbonate glycol.

12. A curing composition comprising one or more blocked isocyanate terminated prepolymers according to claim 9 and one or more curing agent.

13. The curing composition according to claim 12 wherein the one or more curing agent comprises a diamine.

14. The curing composition according to claim 13 wherein the one or more curing agent comprises an aromatic diamine.

15. The curing composition according to claim 12 further comprising from about 0.001 to about 1.0 wt %, based on the weight of the one or more curing agent, of a catalyst.

16. The curing composition according to claim 15 wherein the catalyst comprises one or more of adipic acid, oleic acid, dibutyltin dilaurate or a quaternary ammonium salt.

17. The curing composition according to claim 13 further comprising from about 0.001 to about 1.0 wt %, based on the weight of the one or more curing agent, of a catalyst.

18. The curing composition according to claim 17 wherein the catalyst comprises one or more of adipic acid, oleic acid, dibutyltin dilaurate or a quaternary ammonium salt.

19. A polyurethane polymer obtained by curing the curing composition according to claim 12.

20. A film or molded article comprising the polyurethane polymer according to claim 19.
